(19) United States
(12) Patent Application Publication
(10) Pub. No.: US 2019/0127554 A1
(43) Pub. Date: May 2, 2019

(54) COMPOSITIONS CONTAINING CARBODIIMIDE, ESTER AND PVC, PRODUCTION AND USE THEREOF

(71) Applicant: LANXESS Deutschland GmbH, Köln (DE)

(72) Inventors: Wilhelm LAUFER, Ellerstadt (DE); Thomas FACKLAM, Leverkusen (DE)

(73) Assignee: LANXESS Deutschland GmbH, Cologne (DE)

(21) Appl. No.: 16/096,826

(22) PCT Filed: May 5, 2017
(86) PCT No.: PCT/EP2017/060458

§ 371 Date: Oct. 26, 2018

(30) Foreign Application Priority Data
May 9, 2016 (EP) 16168729.8
May 11, 2016 (EP) 16169225.6

(51) Int. Cl. C08K 5/29; C08L 27/06

(52) U.S. Cl. CPC C08K 5/29; C08L 27/06

(57) ABSTRACT

Plasticizer compositions that are less volatile and have improved resistance to hydrolysis include specific combinations of carbodiimides and specified esters. The plasticizers may include aromatic carbodiimides, and be particularly suited for plastics such as polyvinyl chloride, The carbodiimides and esters may be initially mixed as a pre-mix composition to be added to a polymer, or the polymer, carbodiimides and esters may be mixed together essentially simultaneously to produce a plasticized polymer.

The present invention relates to compositions comprising carbodiimide, esters and PVC, production and use thereof.

The term “plasticizer” in chemical-technical literature refers to substances which are able to convert a hard, brittle substance, simply by mixing thereof, into a soft, extensible, tough or elastic preparation. The term is used in very many different connections. For instance, it is also customary in concrete processing (see for example WO 98 58 887 A1), as in the production of rocket fuel (see for example U.S. Pat. No. 3,617,400). In a narrower sense, the term “plasticizer” refers to additives used in polymer processing which can modify the mechanical properties of thermoplastic polymers in the sense mentioned above. Examples of polymers which are processed with plasticizers are polyvinyl chloride, vinyl chloride-based copolymers, polyvinylidene chloride, polyvinyl acetate, polyvinyl butyral, polyacrylates, polyamides, polylactides, polyurethane, cellulose and derivatives thereof and rubber polymers such as acrylonitrile-butadiene rubber, chloroprene rubber, styrene-butadiene rubbers, chlorinated polyethylene, ethylene-propylene rubber, acrylate rubber, natural rubber and/or epichlorohydrin rubber. Preference is given to polyvinyl chloride.

Diverse esters such as, for example, alkyl esters of benzoic acid, dialkyl esters of aliphatic dicarboxylic acids, e.g. adipic acid diesters, polyesters of aliphatic dicarboxylic acids with aliphatic di-, tri- and tetrols, the end groups of which are non-esterified or have been esterifed with monofunctional reagents, preferably monoalcohols or monocarboxylic acids, and the number-average molar mass of which is 1000-20 000 g/mol, trialkyl esters of citric acid, acetylated trialkyl esters of citric acid, glycerol esters, benzoic acid diesters of mono-, di-, tri- or polyalkylene glycols, trimethylolpropane esters, pentaerythritol esters, dialkyl esters of cyclohexanedicarboxylic acids, dialkyl esters of terephthalic acid, dialkyl esters of phthalic acid, trialkyl esters of trimellitic acid, carboxylic acid esters of polyols, triaryl esters of phosphoric acid, diarylalkyl esters of phosphoric acid, trialkyl esters of phosphoric acid, or aryl esters of alkanesulfonic acids, are known to those skilled in the art as plasticizers for diverse thermoplastic polymers, so-called thermoplastics.

If these are used alone, however, it can lead to stability problems in the plastic. In this case, hydrolysis of the esters used as plasticizer by ambient humidity plays a role.

A wide variety of carbodiimides have proven advantageous in many applications, for example as hydrolysis inhibitors for thermoplastics, ester-based polyols, polyurethanes, triglycerides and lubricating oils etc. However, they have the disadvantage of emitting gases possibly harmful to health.

The object of the present invention, therefore, is to provide novel compositions which are resistant to hydrolysis and less volatile, thus avoiding emissions, and are suitable as plasticizers for plastics, particularly PVC, without these losing their other characteristic properties.

It has now been found that, surprisingly, the aforementioned objects are met if a combination of particular esters, selected from the group comprising

esters of benzoic acid, preferably alkyl esters of benzoic acid, benzoic acid monoesters of C₈-C₁₂-monoalcohols, and benzoic acid diesters of mono-, di-, tri- or polyalkylene glycols,

dialkyl esters of aliphatic dicarboxylic acids,

trialkyl esters of aliphatic tricarboxylic acids, preferably citric acid, and also acetylated trialkyl esters of citric acid,

dialkyl esters or trialkyl esters of aromatic di- or tricarboxylic acids, preferably of terephthalic acid, phthalic acid or trimellitic acid,

dialkyl esters of cyclohexanedicarboxylic acids,

polyesters or carboxylic acid esters of aliphatic dicarboxylic acids with aliphatic di-, tri- and tetrols or polyols, the end groups of which are non-esterified or have been esterified with monofunctional compounds, preferably monoalcohols or monocarboxylic acids, and the number-average molar mass of which is preferably 1000-20 000 g/mol,

glycerol esters,

trimethylolpropane esters,

pentaerythritol esters,

diarylalkyl esters, triaryl esters and/or trialkyl esters of phosphoric acid or

aryl esters of alkanesulfonic acids,

is used with certain carbodiimides.

The present invention therefore relates to compositions containing
(a) at least one polymeric aromatic carbodiimide of formula (I)

R⁴—R⁸—(—N═C═N—R⁸—)ₘ—R⁴ (I),
in which
m represents an integer from 2 to 500, preferably 3 to 20, very particularly preferably 4 to 10,
R⁸ is Cₗ-C₁₂-alkyl-substituted arylenes, C₇-C₁₈-alkylaryl-substituted arylenes and optionally C₁-C₁₂-alkyl-substituted alkylene-bridged arylenes comprising a total of 7 to 30 carbon atoms, and arylene, and
R⁴ is —NCO, —NCNR⁵, —NHCONHR⁵, —NHCONR⁵R⁶ or —NHCOOR⁷,
   wherein R⁵ and R⁶ are identical or different and represent a C₁-C₁₂-alkyl, C₆-C₁₂-cycloalkyl, C₇-C₁₈-aralkyl or aryl radical and R⁷ represents a C₁-C₂₂-alkyl, C₆-C₁₂-cycloalkyl, C₆-C₁₈-aryl or C₇-C₁₈-aralkyl radical and an unsaturated alkyl radical having 2-22 carbon atoms or an alkoxypolyoxyalkylene radical, and
(b) at least one or more esters selected from the group comprising C₉-C₁₀-alkyl esters of benzoic acid, di-(C₈-C₁₂)-alkyl esters of aliphatic dicarboxylic acids, preferably succinic acid, adipic acid and/or sebacic acid, polyesters of branched or unbranched C₂-C₈-aliphatic dicarboxylic acids, preferably succinic acid, adipic acid and/or sebacic acid, or mixtures of these dicarboxylic acids with branched or unbranched C₂-C₈-aliphatic diols or polyols, or mixtures thereof, the end groups of which are non-esterified or have been esterified with monofunctional compounds, preferably C₄-C₁₀-monoalcohols or C₂-C₁₈-monocarboxylic acids, and the number-average molar mass of which is preferably 1000-20 000 g/mol, tri(C₂-C₆)-alkyl esters of citric acid, acetylated tri(C₂-C₆)-alkyl esters of citric acid, glycerol esters, benzoic acid diesters of mono-, di-, tri- or poly(C₂^{-C}₃)-alkylene glycols, trimethylolpropane esters, pentaerythritol esters, di(C₈-C₁₂)-alkyl esters of cyclohexanedicarboxylic acids, di(C₈-C₁₂)-alkyl esters of terephthalic acid, di(C₈-C₁₂)-alkyl esters of phthalic acid, tri(C₈-C₁₂)-alkyl esters of trimellitic acid, carboxylic acid esters of polyols such as, for example, tetra(C₄-C₈)-carboxylic acid esters of pentaerythritol, tri(C₆-C₁₀)-aryl esters of phosphoric acid, di(C₆-C₁₀)-aryl (C₈-C₁₂)-alkyl esters of phosphoric acid, tri(C₈-C₁₂)-alkyl esters of phosphoric acid, or (C₆-C₁₀)-aryl esters of C₁₀-C₂₁-alkanesulfonic acids and
(c) polyvinyl chloride or polyvinyl butyral, especially polyvinyl chloride.

In the context of the invention, further plastics are possible as component (c), which are selected from the series of homo- and copolymers based on ethylene, propylene, butadiene, polyvinyl chloride styrene or acrylonitrile. Particular preference is given to chlorinated polyethylene, nitrile rubber, acrylonitrile-butadiene-styrene copolymers, ethylene-propylene copolymers, ethylene-propylene-diene copolymers, styrene-acrylonitrile copolymers, acrylonitrile-butadiene rubber, styrene-butadiene elastomers.

In the context of the invention, the term alkylene group-bridged arylenes is preferably understood to mean that the respective —N═C═N— groups of the carbodimide are attached to one another via arylene (AR)alkylene (Alk)-arylene (AR)—, in accordance with N═C═N—AR-(Alk)-AR—N═C═N—.

In a preferred embodiment of the invention, the composition according to the invention comprises, as component c), polyvinyl chloride or polyvinyl butyral, particularly preferably polyvinyl chloride.

Preferred polymeric aromatic carbodiimides (a) are carbodiimides having terminal urea and/or urethane groups of the formula

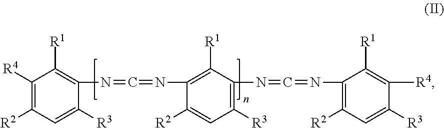

where R⁴ may be identical or different and is selected from the group comprising —NHCONHR⁵, —NHCONR⁵R⁶ or —NHCOOR⁷,

where R⁵ and R⁶ are identical or different and represent a C₁-C₁₂-alkyl, C₆-C₁₂-cycloalkyl, C₇-C₁₈-aralkyl radical or aryl radical,

R⁷ represents a C₁-C₂₂-alkyl, C₆-C₁₂-cycloalkyl, C₆-C₁₈-aryl or C₇-C₁₈-aralkyl radical, and an unsaturated alkyl radical having 2-22 carbon atoms, preferably 12-20, particularly preferably 16-18 carbon atoms, or an alkoxypolyoxyalkylene radical,

R¹, R² and R³ each independently represent methyl or ethyl, wherein each benzene ring bears only one methyl group and n=1 to 10.

Preference is given to carbodiimides of the formula (II) where R⁴═—NHCOOR⁷, in which R⁷ is an alkoxypolyoxyalkylene radical, R¹, R² and R³ are each independently methyl or ethyl, in which each benzene ring comprises only one methyl group and n=1 to 10, preferably n=1 to 4, particularly preferably n=1 to 3.

Preferred alkoxypolyoxyalkylene radicals are polyethylene glycol monomethyl ethers having molar masses of 200-600 g/mol, particularly preferably of 350-550 g/mol.

The carbodiimide content (NCN content measured by titration with oxalic acid) of the carbodiimides of formula (II) employed according to the invention is preferably 2-10% by weight, preferably 4-8% by weight, particularly preferably 5-7% by weight.

Furthermore, the carbodiimides of formula (II) employed according to the invention preferably have average molar masses (Mw) of 1000-5000 g/mol, preferably 1500-4000 g/mol, particularly preferably 2000-3000 g/mol, determined by GPC viscometry.

Furthermore, preference is given to carbodiimides of formula (II) having a polydispersity D=Mw/Mn of 1.2-2.2, particularly preferably 1.4-1.8.

In a further preferred embodiment of the invention, preference is given to carbodiimides having terminal urea and/or urethane groups of the formula (III)

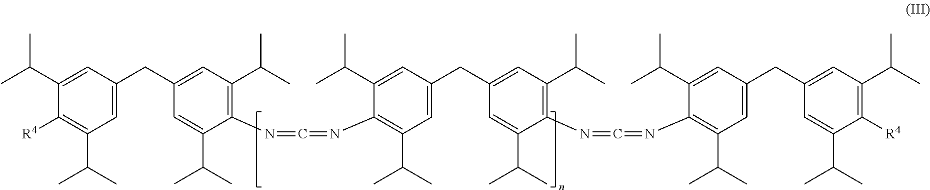

in which

R⁴ is selected from the group comprising —NHCONHR⁵, —NHCONR⁵R⁶ or —NHCOOR⁷,

wherein R⁵ and R⁶ are identical or different and represent a C₁-C₁₂-alkyl, C₆-C₁₂-cycloalkyl, C₇-C₁₅-aralkyl radical or C₆-C₁₅-aryl radical,

R⁷ represents a C₁-C₂₂-alkyl, C₆-C₁₂-cycloalkyl, C₆-C₁₅-aryl or C₇-C₁₅-aralkyl radical, and an unsaturated alkyl radical having 2-22 carbon atoms, preferably 12-20, particularly preferably 16-18 carbon atoms, or an alkoxypolyoxyalkylene radical,

and

n=1 to 20, preferably n=1 to 15.

The carbodiimide content (NCN content, measured by titration with oxalic acid) of the carbodiimides according to the invention, especially of formula (Ill), is preferably 2-10% by weight.

Preferred alkoxypolyoxyalkylene radicals are polyethylene glycol monomethyl ethers having molar masses of 200-600 g/mol, particularly preferably of 350-550 g/mol.

Preference is given to carbodiimides of formula (III) where R═—NHCOO⁷ radical where R⁷ is an alkoxypolyoxyalkylene or an unsaturated alkyl radical having 18 carbon atoms, and n=0 to 20, preferably n=1 to 10, particularly preferably n=2 to 8, very particularly preferably n=3 to 6.

The carbodiimide content of these preferred carbodiimides of formula (III) is preferably 2-8% by weight, particularly preferably 3-6% by weight, very particularly preferably 4-5% by weight.

Furthermore, the carbodiimides according to the invention, especially of formula (III), preferably have average molar masses (Mw) of 1000-10 000 g/mol, preferably 2000-8000 g/mol, particularly preferably 3000-6000 g/mol, determined by GPC viscometry.

The carbodiimides according to the invention are commercially available compounds. However, they may also be produced for example by the processes described in EP14191710.4.

In the context of the invention, esters used as component b) are preferably polyesters of 1,2-propanediol and/or 1,3- and/or 1,4-butanediol and/or diethylene glycol and/or dipropylene glycol and/or polypropylene glycol and/or glycerol and/or pentaerythritol with adipic acid and/or sebacic acid and/or succinic acid, also end-capped with acetic acid, and/or C₁₀-C₁₈-fatty acids, and/or 2-ethylhexanol, and/or isononanol and/or n-octanol and/or n-decanol and also di(2-ethylhexyl) adipate, diisononyl adipate, diisononyl phthalate, dipropylheptyl phthalate, diisononyl 1,2-cyclohexanedicarboxylate, di(2-ethylhexyl) 1,2-cyclohexanedicarboxylate, pentaerythritol tetravalerate, di(2-ethylhexyl) terephthalate, tri(2-ethylhexyl) trimellitate, diphenyl isodecyl phosphate, diphenyl 2-ethylhexyl phosphate, isopropylphenyl diphenyl phosphate, tert-butylphenyl diphenyl phosphate and phenyl (C₁₀-C₂₁)-alkanesulfonate.

Components (b) and (a) are preferably used in this case in a ratio from 200:1 to 10:1 parts by weight, preferably from 50:1 to 20:1 parts by weight, particularly preferably 40:1 to 30:1 parts by weight.

In the context of the invention, the polyvinyl chlorides or polyvinyl butyrates c) used are preferably commercial polymers such as are obtainable, for example, from Inovyn Deutschland GmbH. The polyvinyl chloride present in the composition according to the invention is preferably prepared by homopolymerization of vinyl chloride according to methods known to those skilled in the art, such as suspension, microsuspension, emulsion or bulk polymerization.

In a further preferred embodiment of the invention, the composition also comprises additives d).

In these cases in which the polyvinyl chloride or polyvinyl butyral c), polymeric aromatic carbodiimide a), at least one or more esters b) and optionally further additives d) is omitted, this preferably has

200 parts by weight of one or more esters b) : 1 part by weight of polymeric aromatic carbodiimide a)

to 10 parts by weight of one or more esters b): 1 part by weight of polymeric aromatic carbodiimide a) and

the sum total of polymeric aromatic carbodiimide a) and one or more esters (plasticizers) b) corresponds to an amount of 10-100 parts by weight per 100 parts by weight of polyvinyl chloride.

In a further preferred embodiment, the polyvinyl chloride-containing composition comprises preferably 40 parts by weight of one or more esters b): 1 part by weight of polymeric aromatic carbodiimide a)

to 30 parts by weight of one or more esters b): 1 part by weight of polymeric aromatic carbodiimide c), wherein

the sum total of polymeric aromatic carbodiimide a) and one or more esters (plasticizers) b) corresponds to an amount of 10-100 parts by weight per 100 parts by weight of polyvinyl chloride.

In a further embodiment, the present invention relates to a composition comprising a) and b), polyvinyl chloride or polyvinyl butyral c), and one or more additives d) selected from the group comprising PVC stabilizers, lubricants, fillers, pigments, flame retardants, light stabilizers, blowing agents, polymeric processing aids, impact modifiers, optical brighteners and antistatic agents such as, for example, sodium (C₁₃-C₁₇)-alkyl sulfonates and glycerol monooleate.

In this case, preference is given to a composition comprising a) and b), polyvinyl chloride or polyvinyl butyral c), and one or more additives d) selected from the group comprising PVC stabilizers, lubricants, fillers, pigments, flame retardants, light stabilizers, blowing agents, polymeric processing aids, impact modifiers, optical brighteners and antistatic agents such as, for example, sodium (C₁₃-C₁₇)-alkyl sulfonates and glycerol monooleate.

These additives d) can be present in any combination. Some suitable additives are described in greater detail below. The examples listed do not represent any limitation to the polyvinyl chloride preparation according to the invention but serve only for elucidation. All % figures refer to the weight of the entire polyvinyl chloride preparation in the case of the polyvinyl chloride-containing composition, otherise to the weight of the composition composed of components a) and b).

The additives d) mentioned below, such as preferably stabilizers, lubricants, plasticizers, fillers, pigments, flame retardants, light stabilizers, blowing agents, polymeric processing aids and/or impact modifiers, are therefore also usable in combination with a) and b) without polyvinyl chloride or polyvinyl butyral c) being present.

PVC stabilizers neutralize the hydrochloric acid eliminated during and/or after processing the polyvinyl chloride. Suitable as PVC stabilizers are all customary polyvinyl chloride stabilizers in solid and liquid form, for example epoxy/zinc, Ca/Zn, Ba/Zn, Pb or Sn stabilizers and also metal-free stabilizers and also acid-binding sheet silicates such as hydrotalcite. Compositions according to the invention, preferably polyvinyl chloride-containing compositions, may comprise preferably 0-7%, preferably 0.1-5%, particularly preferably 0.2-4% and especially 0.5-3% stabilizers.

In a further preferred embodiment, lubricants should be effective between the polyvinyl chloride particles and should counteract frictional forces during mixing, plasticizing and forming. Lubricants which may be present in the polyvinyl chloride-containing compositions according to the invention include all lubricants customary for the processing of plastics, preferably hydrocarbons, particularly preferably oils, paraffins and PE waxes, fatty alcohols having 6 to 20 carbon atoms, ketones, carboxylic acids, preferably fatty acids or montanic acids, oxidized PE wax, metal salts of carboxylic acids, carboxamides and carboxylic esters, preferably with the alcohols ethanol, fatty alcohols, glycerol, ethanediol, pentaerythritol or long-chain carboxylic acids as the acid component. The compositions according to the invention, preferably polyvinyl chloride-containing compositions, preferably comprise 0-10%, preferably 0-5%, particularly preferably 0.1-3% and especially 0.2-2% lubricant.

In a further preferred embodiment, fillers especially influence the pressure resistance, tensile strength and flexural strength and also the hardness and heat distortion resistance of plasticized polyvinyl chloride in a positive manner. The compositions according to the invention, preferably polyvinyl chloride-containing compositions, may contain as fillers carbon black, natural calcium carbonates such as chalk, limestone and marble, synthetic calcium carbonates, dolomite, silicates, silica, sand, diatomaceous earth, aluminum silicates such as kaolin, mica and feldspar, other inorganic fillers and organic fillers such as wood flour, wood chippings or wood fibers. Preferred fillers used are calcium carbonates, chalk, dolomite, kaolin, silicates, talc or carbon black. The composition according to the invention, preferably polyvinyl chloride-containing composition, comprises preferably 0-80%, preferably 0.1-60%, particularly preferably 0.5-50% and especially 1-40% fillers.

The compositions according to the invention, preferably polyvinyl chloride-containing compositions, may also comprise pigments, in order to adapt the color of the resulting product to different use possibilities. For this purpose, both inorganic pigments and organic pigments are used. It is possible to use inorganic pigments, for example, cadmium pigments such as CdS, cobalt pigments such as CoO/Al₂O₃, and chromium pigments, for example Cr₂O₃. Suitable organic pigments are, for example, monoazo pigments, condensed azo pigments, azomethine pigments, anthraquinone pigments, quinacridones, phthalocyanine pigments, dioxazine pigments and aniline pigments. The composition according to the invention, preferably polyvinyl chloride-containing composition, comprises preferably 0-10%, preferably 0.05-5%, particularly preferably 0.1-3% and especially 0.5-2% pigments.

To reduce flammability and to reduce smoke evolution on combustion, the compositions according to the invention, preferably polyvinyl chloride-containing compositions, may also comprise flame retardants. Flame retardants used are preferably antimony trioxide, phosphoric esters, chloroparaffin, aluminum hydroxide, boron compounds, zinc compounds, molybdenum trioxide, ferrocene, calcium carbonate or magnesium carbonate. The composition according to the invention, preferably polyvinyl chloride-containing composition, comprises preferably 0-30%, preferably 0.1-25%, particularly preferably 0.2-20% and especially 0.5-15% flame retardants.

To protect articles that have been prepared from the polyvinyl chloride preparation according to the invention from any damage by the effect of light, light stabilizers may be added. For this purpose, preference is given to using hydroxybenzophenones or hydroxyphenylbenzotriazoles. The composition according to the invention, preferably polyvinyl chloride-containing composition, comprises preferably 0-7%, preferably 0.1-5%, particularly preferably 0.2-4% and especially 0.5-3% light stabilizers.

The composition according to the invention, preferably polyvinyl chloride-containing composition, may be used for producing foams using blowing agents. For this purpose, chemical or physical blowing agents are preferably added to this composition. Suitable chemical blowing agents include all substances known for this purpose, preferably azodicarbonamide, p-toluenesulfonyl hydrazide, 4,4′-oxybis(benzenesulfohydrazide), p-toluenesulfonyl semicarbazide, 5-phenyltetrazole, N,N′-dinitrosopentamethylenetetramine, zinc carbonate or sodium hydrogencarbonate and also mixtures comprising these substances. Suitable physical blowing agents are preferably carbon dioxide or halogenated hydrocarbons. The composition according to the invention, preferably polyvinyl chloride-containing composition, comprises preferably 0-20%, preferably 0.05-15%, particularly preferably 0.1-10% and especially 0.7-3% blowing agents.

The composition according to the invention, preferably polyvinyl chloride-containing composition, may also comprise further plastics which, for example, act as polymeric processing aids or impact modifiers. These further plastics are preferably selected from the series comprising homo- and copolymers based on ethylene, propylene, butadiene, vinyl acetate, glycidyl acrylate, glycidyl methacrylate, acrylates and methacrylates with alcohol components of branched or unbranched C1 to C10 alcohols, styrene or acrylonitrile. Particular preference is given to polyacrylates with identical or different alcohol radicals from the group comprising C4 to C8 alcohols, especially butanol, hexanol, octanol and 2-ethylhexanol, polymethylmethacrylate, methyl methacrylate-butyl acrylate copolymers, methyl methacrylate-butyl methacrylate copolymers, ethylene-vinyl acetate copolymers, chlorinated polyethylene, nitrile rubber, acrylonitrile-butadiene-styrene copolymers, ethylene-propylene copolymers, ethylene-propylene-diene copolymers, styrene-acrylonitrile copolymers, acrylonitrile-butadiene rubber, styrene-butadiene elastomers and methyl methacrylate- styrene-butadiene copolymers.

When used, especially as plasticizers, the compositions of a) and b) according to the invention have good performance characteristics, in particular they allow the low-emission production of the plasticized end product. The use of the compositions according to the invention in plasticized plastics, preferably polyvinyl chloride c), enables the production of more durable products, due to the stabilization to hydrolysis of the ester b).

The compositions according to the invention can be produced in a known manner by mixing components a) and b) and at least one polyvinyl chloride or polyvinyl butyral c) and optionally at least one additive d) in the ratios specified for these components in a mixing apparatus, preferably in stirring and mixing units, dilution systems and static mixers. In this case, components a) and b) of the composition according to the invention can initially be mixed and can then be mixed with the components c) and optionally d) used, or both components a) and b) can be added separately to the components c) and optionally d) and then they can be mixed.

The polyvinyl chloride compositions according to the invention may be mixed as dry blends, or liquid mixtures or pastes, and optionally after additional processing to granules, may be further processed.

Such processing operations are, but are not limited to, extruding, injection molding, spraying, calendaring, rotational molding, dipping, spreading, coating, sintering and casting.

The present invention also provides a process for producing plastic, especially polyvinyl chloride, which is characterized in that at least one plastic, especially polyvinyl chloride c), is mixed with an inventive composition comprising a) and b) in a mixing apparatus and is homogenized, the mixture is then shaped, especially molded by extruding, injection molding, spraying, calendaring, rotational molding, dipping, spreading, coating, sintering or casting and the shaped mixture is then heated, preferably to a temperature in the range from 150 to 220° C.

The plastics, especially polyvinyl chloride c), produced by the compositions according to the invention, are also a subject matter of the present invention.

These plastics according to the invention, especially composed of polyvinyl chloride in particular, may be further processed. End products of this kind are, in particular, floors, carpets, artificial leather, profiles, wire and cable sheathings, films, coatings and coating compositions, paints, dyes, inks, adhesives, sealants, and components of adhesives, sealants and adhesive sealants.

The invention further relates in addition to the use of the composition according to the invention for producing the end products mentioned.

The scope of the invention encompasses all hereinabove and hereinbelow recited general or preferred definitions of radicals, indices, parameters and elucidations among themselves, i.e. including between the respective ranges and preferences in any combination.

The examples which follow serve to elucidate the invention but have no limiting effect.

### WORKING EXAMPLES

Determination of the Hydrolysis Stability:

In a porcelain dish, 100 g of polyvinyl chloride c) (Vinnolit® S4170, Vinnolit GmbH & Co. KG, Germany), were mixed with 60 phr (parts by weight per 100 parts by weight PVC) of a polyester of adipic acid and 1,2-propanediol/butanediol and 2-ethylhexanol (10 parts adipic acid, 10.6 parts diol (composed of 5.3 parts 1,2-propanediol and 5.3 parts 1,4-butanediol) and 1 part ethylhexanol having an average molar weight of about Mw=7500 g/mol) b), viscosity 12 000 mPas at 23° C.) and 2 parts of a polymeric aromatic carbodiimide CDI 1 or CDI 2 where CDI 2=carbodiimide of the formula (II) where n=ca. 4 and R¹, R², R³=each independently methyl or ethyl, in which each benzene ring has only one methyl group, R⁴═—NHCOOR⁷ where R⁷=cyclohexyl and CDI 1=carbodiimide of the formula (III) where n=ca. 4 and R⁴═—NHCOOR⁷ where R⁷=cyclohexyl and 3 phr PVC stabilizer (Ca/Zn carboxylate) d), using a rod such that the liquid constituents were well absorbed by the powder and did not stick to the vessel. The powder mixture thus obtained was fed portionwise into the roller gap (0.7 mm) of a twin roll mill at 165° C. roll temperature and homogenized and gelated. Once a milled sheet had been formed, the roller gap was widened to 1 mm. The mixing result was improved by frequent impacting of the milled sheet. After a mixing and processing time of 10 minutes, the milled sheet was removed. After portioning, test films were pressed (200 mm×200 mm×1 mm). The temperature of the press was 170° C.; the pressing time was 10 minutes in total, of which minutes was a heating phase at a pressure <10 bar and 3 minutes was a pressing time under high pressure >100 bar. After cooling under pressure in a cooling press at a maximum of 30° C., the test specimens were demolded. The test films were weighed out to a precision of 0.0001 g. Thereafter, a test film was stored for 14 days in an oven at 70° in an atmosphere saturated with moisture by water. After removing the test films, these are freed from moisture or droplets potentially adhering thereto and weighed after 2 days of conditioning at 20° C. and 40% humidity.

Before and after oven storage, an S4 bar was punched out from each type of film and in the tensile test (Ametek Lloyd Instruments shredding machine LRSKplus, withdrawal speed 200 mm/min) the 100% strain before and after storage was determined and evaluated as percentage difference from the starting value of the non-stored film.

Plasticizing Effect

To determine the plasticizing effect of the composition according to the invention, milled sheets of polyvinyl chloride compounds of the composition specified in Table 1 were produced. Test specimens of 35 mm diameter were pressed from the milled sheets, of which the Shore hardness was determined by means of a digital Shore hardness tester (Zwick GmbH & Co. KG, Ulm). The results (average values of five measurements each) of this test are reported in Table 2.

TABLE 1
Composition (parts by weight) of the mixtures
for the test specimens of inventive Examples
B1 and B2 and of the comparative Example C1.

| | C1 | B1 | B2 |
|---|---|---|---|
| PVC (c) | 100 | 100 | 100 |
| Adipic acid polyester (b) | 60 | 60 | 60 |
| Ca/Zn carboxylate (d) | 3 | 3 | 3 |
| CDI 1 (a) | 0 | 2 | 0 |
| CDI 2 (a) | 0 | 0 | 2 |

Where CDI 1 = carbodiimide of the formula (III) where n = ca. 4 and R⁴ = —NHCOOR⁷ where R⁷ = cyclohexyl, weight average molar mass: ca. 6000 g/mol, D = 1.84, where CDI 2 = carbodiimide of the formula (II) where n = ca. 4 and R¹, R², R³ = each independently methyl or ethyl, in which each benzene ring has only one methyl group, R⁴ = —NHCOOR⁷ where R⁷ = cyclohexyl, weight average molar mass: ca. 2500 g/mol, D = 1.85. The respective molar masses were determined by GPC viscometry.

TABLE 2
The Shore hardness of the non-stored test specimens, the
differences by weight of the test plates and the differences
in the 100% strain of the S4 rods before/after oven storage
in moisture-saturated atmosphere of the inventive Examples
B1 and B2 and of the comparative Example C1.

| | C1 | B1 | B2 |
|---|---|---|---|
| Shore A | 82 | 81 | 81 |
| Weight changes of the test | −0.6% | +/−0.0% | +0.1% |
| plates after oven storage | | | |
| Change in stress at 100% strain | 117 | 112 | 111 |
| after oven storage | | | |

Evaluation of the Plasticizing Effect

The plasticizing effect of various plasticizers at identical amounts may be compared by means of hardness determinations. As the measurement results of Table 1 show, polyvinyl chloride compounds can be prepared with the compositions according to the invention, the degrees of hardness of which are not negatively affected by mixing in the carbodiimides CDI 1 and CDI 2 (Examples B1 and B2) in comparison (Example C1).

Evaluation of Weight Change and Stress at 100% Strain

By addition of component a) (Examples B1 and B2), the degradation of ester (plasticizer) b) induced by humidity and the weight reduction associated therewith is reduced in comparison to Example Cl without aromatic polymeric carbodiimide and the change with respect to the increase of the stress at 100% strain is reduced.

Evaluation

It is shown, therefore, that the compositions according to the invention have the desired plasticizing properties, wherein the sensitivity to hydrolysis of the ester is effectively prevented by the polymeric aromatic carbodiimide, especially in PVC, see Table 2.

Compatibility Investigations:

For this purpose, the plasticizer-containing PVC powder mixture to be tested was homogenized and gelated on a dual roller mill and subsequently pressed to form smooth test films and the mass loss under hot humid storage was determined.

In a porcelain dish, 100 g of polyvinyl chloride (S-PVC, K 70) were mixed with 100 phr (parts by weight per 100 parts by weight PVC) plasticizer, 3 phr Ca/Zn carboxylate as PVC stabilizer and optionally 2 phr CDI 2, using a rod, such that the liquid constituents are well absorbed by the powder and did not stick to the vessel. The powder mixture thus obtained was fed portionwise into the roller gap (0.7 mm) of a dual roller mill at 165° C. roll temperature and homogenized and gelated. Once a milled sheet had been formed, the roller gap was widened to 1 mm. The mixing result was improved by frequent impacting of the milled sheet. After a mixing and processing time of 10 minutes, the milled sheet was removed. After portioning, 1 mm thickness test films were pressed. The temperature of the press was 170° C.; the pressing time was 10 minutes in total, of which 7 minutes was a heating phase at a pressure <10 bar and 3 minutes was a pressing time under high pressure >100 bar. After cooling under pressure in a cooling press at a maximum of 30° C., the test specimens were demolded and plates cut of dimension 200 mm×100 mm. The test films were weighed out to a precision of 0.0001 g. The films were suspended in a well-sealable glass container and stored at 70° C. over water for 28 days. After 28 days the films were withdrawn from the glass vessel and climatized for 1 hour freely suspended in air. Subsequently, the films were surface cleaned with methanol. The films were then dried freely suspended at 70° C. for 16 hours in a drying cabinet with forced convection. After removing from the drying cabinet, the films were climatized freely suspended for 1 hour and subsequently weighed. A lower percentage content of weight loss of the test films is evidence of the lower volatility, lower emissions and good resistance of the plasticizer to exudation and of the stabilizing effect of the inventive carbodiimide CDI 2.

Comparative experiments 1, 3 and 5 without carbodiimide (see Table 3) show a high weight loss for the test specimens having a high proportion of polymeric adipic acid polyester and a decrease in weight loss depending on the addition of monomeric adipic acid ester, in this case di(2-ethylhexyl) adipate.

TABLE 3
Comparative Examples without carbodiimide

| | | 2 | | 4 | | 6 |
|---|---|---|---|---|---|---|
| Composition [w/w] | 1 (C) | (inv) | 3 (C) | (inv) | 5 (C) | (inv) |
| Suspensions PVC (K 70) * | 100 | 100 | 100 | 100 | 100 | 100 |
| Calcium zinc stabilizer ** | 3 | 3 | 3 | 3 | 3 | 3 |
| Adipic acid polyester *** | 100 | 100 | 80 | 80 | 0 | 0 |
| Di(2-ethylhexyl) | 0 | 0 | 20 | 20 | 100 | 100 |
| adipate **** | | | | | | |
| CDI 2 | 0 | 2 | 0 | 2 | 0 | 2 |
| Result after storage | −22.3 | −12.5 | −15.7 | −5.0 | −0.8 | −0.3 |
| in hot humid environment | | | | | | |
| Weight difference [%] | | | | | | |

* Vinnolit S 4170 from Vinnolit GmbH & Co. KG
** Mark CZ11 from Galata Chemicals GmbH
*** Ultramoll IV from Lanxess Deutschland GmbH
**** Adimoll DO from Lanxess Deutschland GmbH

The mixtures according to the invention in Examples 2, 4 and 6 (Table 3) show, in direct comparison with Examples 1, 3 and 5, a surprisingly lower weight decrease on storage in a hot humid climate, i.e. higher resistance to hydrolysis, emissions and volatility.

1. A composition comprising:
(a) at least one polymeric aromatic carbodiimide of formula (I)
R⁴—R⁸—(—N═C═N—R⁸—)ₘ—R⁴ (I),
in which
m represents an integer from 2 to 500,
R⁶ is C₁-C₁₂-alkyl-substituted arylenes, C₇-C₁₈alkylaryl-substituted arylenes and optionally C₁-C₁₂-alkyl-substituted alkylene bridged arylenes comprising a total of 7 to 30 carbon atoms, and arylene, and
R⁴ is —NCO, —NCNR⁵, —NHCONR⁵R⁸ or NHCOOR⁷, wherein
R⁵ and R⁶ are identical or different and represent a C₁-C₁₂-alkyl, C₆-C₁₂-cycloalkyl, C₇-C₁₈aralkyl, or aryl radical, and
R⁷ represents a C₁-C₂₂-alkyl, C₆-C₁₂-cycloalkyl, C₆-C₁₈aryl, or C₇-C₁₈-aralkyl radical and an unsaturated alkyl radical having 2-22 carbon atoms or an alkoxypolyoxyalkylene radical;
(b) at least one ester selected from the group consisting of C₉-C₁₀-alkyl esters of benzoic acid, di-(C₈-C₁₂)-alkyl esters of aliphatic dicarboxylic acids, polyesters of aliphatic dicarboxylic acids, and mixtures of these dicarboxylic acids with C₂-C₈-aliphatic dials or polyols, the end groups of which are non-esterified or have been esterified with monofunctional compounds, tri(C₂-C₆)-alkyl esters of citric acid, acetylated tri(C₂-C₆)-alkyl esters of citric acid, glycerol esters, benzoic acid diesters of mono-, di-, tri- or poly(C₂-C₃)-alkylene glycols, trimethylolpropane esters, pentaerythritol esters, di(C₈-C₁₂)-alkyl esters of cyclohexanedicarboxylic acids, di(C₄-C₁₂)-alkyl esters of terephthalic acid, di(C₆-C₁₂)-alkyl esters of phthalic acid, tri(C₆-C₁₂)-alkyl esters of trimellitic acid, tri(C₆-C₁₀)-aryl esters of phosphoric acid, di(C₆-C₁₀)-aryl(C₈-C₁₂)-alkyl esters of phosphoric acid, tri(C₁₀-C₁₂)-alkyl esters of phosphoric acid, and (C₆-C₁₀)-aryl esters of C₁₀-C₂₁-alkanesulfonic acids; and
(c) a polymer.

2. The composition as claimed in claim 1, wherein the polymeric aromatic carbodiimides are compounds of formula (II), 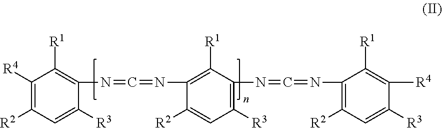
where
R⁴ is selected from the group consisting of —NHCONHR⁵, —NHCONR⁵R⁵ or —NHCOOR⁷, wherein
R⁵ and R⁶ are identical or different, and represent a C₁-C₁₂-alkyl, C₆-C₁₂-cycloalkyl, C₇-C₁₈aralkyl radical, or aryl radical, and
R⁷ represents a C₁-C₂₂-alkyl, C₆-C₁₂-cycloalkyl, C₆-C₁₈-aryl, or C₇-C₁₈-aralkyl radical, and an unsaturated alkyl radical having 2-22, carbon atoms, or an alkoxypolyoxyalkylene radical;
R¹, R² and R³ each independently represent methyl or ethyl, wherein each benzene ring bears only one methyl group; and
n=1 to 10.

3. The composition as claimed in claim 1, wherein the polymeric aromatic carbodiimides are compounds of formula (III) 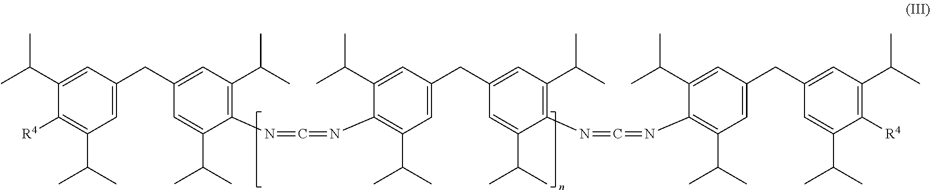
in which
R⁴ is selected from the group comprising —NHCONHR⁵, —NHCONR⁵R⁶ or —NHCOOR⁷, wherein
R⁵ and R⁶ are identical or different and represent a C₁-C₁₂-alkyl, C₆-C₁₂-cycloalkyl, C₇-C₁₈-aralkyl radical or C₆-C₁₈-aryl radical,
R⁷ represents a C₁-C₂₂-alkyl, C₆-C₁₂-cycloalkyl, C₆-C₁₈-aryl or C₇-C₁₅-aralkyl radical, and an unsaturated alkyl radical having 2-22 carbon atoms, or an alkoxypolyoxyalkylene radical, and
n=1 to 20.

4. The composition as claimed in claim 1, wherein the ester is a polyester of 1,2-propanediol and/or 1,3- and/or 1,4-butanediol and/or diethylene glycol and/or dipropylene glycol and/or polypropylene glycol and/or glycerol and/or pentaerythritol and/or 2,2-dimethyl-1,3-propanediol with adipic acid and/or sebacic acid and/or succinic acid and/or phthalic acid, optionally also end-capped with acetic acid, and/or C₁₀-C₁₈-fatty acids, and/or 2-ethylhexanol, and/or isononanol and/or n-octanol and/or n-decanol and also di(2-ethylhexyl) adipate, diisononyl adipate, dipropylheptyl phthalate, diisononyl phthalate, diisononyl 1,2-cyclohexanedicarboxylate, di(2-ethylhexyl) 1,2-cyclohexanedicarboxylate, pentaerythritol tetravalerate and di(2-ethylhexyl) terephthalate, tri(2-ethylhexyl) trimellitate, diphenyl isodecyl phosphate, diphenyl 2-ethylhexyl phosphate, isopropylphenyl diphenyl phosphate, tart-butylphenyl diphenyl phosphate and phenyl (C₁₀-C₂₁)-alkanesulfonate.

5. The composition as claimed in claim 1, wherein a ratio of (b) to (a) is 200:1 to 10:1 parts by weight, particularly preferably 40:1 to 30:1 parts by weight.

6. The composition as claimed in claim 1, wherein the composition comprises 200 to 10 parts by weight of the one or more esters to 1 part by weight of the polymeric aromatic carbodiimide, and the sum total of the polymeric aromatic carbodiimide and the one or more ester(s) corresponds to an amount of 10-100 parts by weight per 100 parts by weight of the polyvinyl chloride or polyvinylbutyral.

7. The composition as claimed in claim 1, further comprising one or more additives d) selected from the group consisting of PVC stabilizers, lubricants, fillers, pigments, flame retardants, light stabilizers, blowing agents, polymeric processing aids, and impact modifiers.

8. A process for producing the composition as claimed in claim 1, the process comprising mixing together components a) and b) to produce a first mixture, and then mixing component c) and optionally one or more additives d) into the first mixture.

9. An article of manufacture comprising the composition as claimed in claim 1 wherein the article of manufacture comprises pipelines, cables, wire sheathings, floor coverings, medical articles, food packaging, gaskets, films, composite films, films for composite safety glass, synthetic leather, toys, packaging containers, adhesive strip films, clothing, coatings, and also fibers for fabric.

10. The composition as claimed in claim 1, wherein the ratio of (b) to (a) is 40:1 to 30:1 parts by weight.

11. The composition as claimed in claim 2, wherein in the compounds of the formula (II), R⁷ represents a C₁-C₂₂-alkyl, C₆-C₁₂-cycloalkyl, C₆-C₁₈-aryl, or C₇-C₁₈-aralkyl radical, and an unsaturated alkyl radical having 16-18 carbon atoms, or an alkoxypolyoxyalkylene radical.

12. The composition as claimed in claim 3, wherein, in the compounds of the formula (III):
A⁷ represents a C₁-C₂₂-alkyl, C₆-C₁₂-cycloalkyl, C₆-C₁₈-aryl, or C₇-C₁₈-aralkyl radical, and an unsaturated alkyl radical having 16-18 carbon atoms, or an alkoxypolyoxyalkylene radical, and
n=1 to 15.

13. The composition as claimed in claim 12, wherein the ester is a polyester of 1,2-propanediol and/or 1,3- and/or 1,4-butanediol and/or diethylene glycol and/or dipropylene glycol and/or polypropylene glycol and/or glycerol and/or pentaerythritol and/or 2,2-dimethyl-1,3-propanediol with adipic acid and/or sebacic acid and/or succinic acid and/or phthalic acid, optionally also end-capped with acetic acid, and/or C₁₀-C₁₈-fatty acids, and/or 2-ethylhexanol, and/or isononanol and/or n-octanol and/or n-decanol and also di(2-ethylhexyl) adipate, diisononyl adipate, dipropylheptyl phthalate, diisononyl phthalate, diisononyl 1,2-cyclohexanedicarboxylate, di(2-ethylhexyl) 1,2-cyclohexanedicarboxylate, pentaerythritol tetravalerate and di(2-ethylhexyl) terephthalate, tri(2-ethylhexyl) trimellitate, diphenyl isodecyl phosphate, diphenyl 2-ethylhexyl phosphate, isopropylphenyl diphenyl phosphate, tart-butylphenyl diphenyl phosphate and phenyl (C₁₀-C₂₁)-alkanesulfonate.

14. The composition as claimed in claim 13, wherein:
the ratio of (b) to (a) is 40:1 to 30:1 parts by weight; and
the polymer is polyvinyl chloride; and
the sum total of polymeric aromatic carbodiimide and one or more esters corresponds to an amount of 10-100 parts by weight per 100 parts by weight of polyvinyl chloride.

15. The composition according to claim 1, wherein:
in formula (I), m represents an integer from 3 to 20;
the at least one ester is selected from the group consisting of C₉-C₁₀-alkyl esters of benzoic acid, di-(C₆-C₁₂)-alkyl esters of succinic acid, adipic acid and/or sebacic acid, polyesters of succinic acid, adipic acid and/or sebacic acid, or mixtures of these dicarboxylic acids with C₂-C₈-aliphatic diols or polyols, the end groups of which are non-esterified or have been esterified with C₄-C₁₀-monoalcohols or C₂-C₁₈-monocarboxylic acids, and the number-average molar mass of which is 1000-20,000 g/mol, tri(C₂-C₆)-alkyl esters of citric acid, acetylated tri(C₂-C₆)-alkyl esters of citric acid, glycerol esters, benzoic acid diesters of mono-, di-, tri- or poly(C₂-C₃)-alkylene glycols, trimethylolpropane esters, pentaerythritol esters, di(C₈-C₁₂)-alkyl esters of cyclohexanedicarboxylic acids, di(C₄-C₁₂-alkyl esters of terephthalic acid, di(C₈-C₁₂)-alkyl esters of phthalic acid, tri(C₈-C₁₂)-alkyl esters of trimellitic acid, tri(C₆-C₁₀)-aryl esters of phosphoric acid, di(C₆-C₁₀)-aryl(C₈-C₁₂)-alkyl esters of phosphoric acid, tri(C₈-C₁₂)-alkyl esters of phosphoric acid, and (C₆-C₁₀)-aryl esters of C₁₀-C₂₁-alkanesulfonic acids; and
the polymer is selected from the group consisting of polyvinyl chloride, vinyl chloride-based copolymers, polyvinylidene chloride, polyvinyl acetate, polyvinyl butyral, polyacrylates, polyamides, polylactides, polyurethane, cellulose and derivatives thereof, acrylonitrile-butadiene rubber, chloroprene rubber, styrene-butadiene rubbers, chlorinated polyethylene, ethylene-propylene rubber, acrylate rubber, natural rubber, and epichlorohydrin rubber,

16. The composition according to claim 15, wherein:
in formula (I), m represents an integer from 4 to 10;
the polymer is polyvinyl chloride or polyvinyl chloride or polyvinyl butyral; and
the ratio of (b) to (a) is 40:1 to 30:1 parts by weight,

17. The composition as claimed in claim 16, wherein:
the polymer is polyvinyl chloride; and
the sum total of polymeric aromatic carbodiimide and one or more esters corresponds to an amount of 10-100 parts by weight per 100 parts by weight of polyvinyl chloride.

18. A plasticizer comprising:
at least one polymeric aromatic carbodiimide of formula (I)
R⁴—R⁸—(—N═C═N—R⁸—)ₘ—R⁴ (I),
in which
m represents an integer from 2 to 500,
R⁸ is C₁-C₁₂-alkyl-substituted arylenes, C₇-C₁₈-alkylaryl-substituted arylenes and optionally C₁-C₁₂-alkyl-substituted alkylene-bridged arylenes comprising a total of 7 to 30 carbon atoms, and arylene, and
R⁴ is —NCO, —NCNR⁵, —NHCONHR⁵, —NHCONR⁵R⁶ or —NHCOOR⁷, wherein
R⁵ and R⁶ are identical or different and represent a C₁-C₁₂-alkyl, C₆-C₁₂-cycloalkyl, C₇-C₁₈-aralkyl, or aryl radical, and
R⁷ represents a C₁-C₂₂-alkyl, C₆-C₁₂-cycloalkyl, C₆-C₁₈-aryl, or C₇-C₁₈-aralkyl radical and an unsaturated alkyl radical having 2-22 carbon atoms or an alkoxypolyoxyalkylene radical; and
(b) at least one ester selected from the group consisting of C₉-C₁₀-alkyl esters of benzoic acid, di-(C₈-C₁₂)-alkyl esters of aliphatic dicarboxylic acids, polyesters of aliphatic dicarboxylic acids, and mixtures of these dicarboxylic acids with C₂-C₈-aliphatic diols or polyols, the end groups of which are non-esterified or have been esterified with monofunctional compounds, tri(C₂-C₈)-alkyl esters of citric acid, acetylated tri(C₂-C₆)-alkyl esters of citric acid, glycerol esters, benzoic acid diesters of mono-, di-, tri- or poly(C₂-C₃)-alkylene glycols, trimethylolpropane esters, pentaerythritol esters, di(C₈-C-₁₂)-alkyl esters of cyclohexanedicarboxylic acids, di(C₄-C₁₂)-alkyl esters of terephthalic acid, di(C₈-C₁₂)-alkyl esters of phthalic acid, tri(C₈-C₁₂)-alkyl esters of trimellitic acid, tri(C₆-C₁₀)-aryl esters of phosphoric acid, di(₆-C₁₀)-aryl(C₈-C₁₂)-alkyl esters of phosphoric acid, tri(C₈-C₁₂)-alkyl esters of phosphoric acid, and (C₆-C₁₀)-aryl esters of C₁₀-C₂₁-alkanesulfonic acids.

19. The plasticizer according to claim 18, wherein the polymeric aromatic carbodiimides are at least one of:
compounds of formula (II) 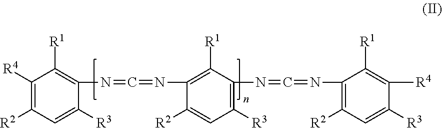
where n=1 to 10, and
compounds of formula (III) 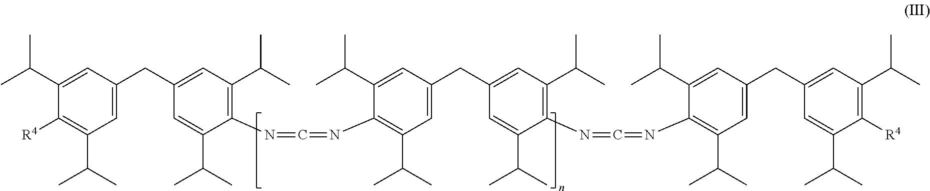
where n=1 to 20, and
R⁴ is selected from the group consisting of —NHCONHR⁵, —NHCONR⁵R⁶ or —NHCOOR⁷, wherein
R⁵ and R⁶ are identical or different, and represent a C₁-C₁₂-alkyl, C₆-C₁₂-cycloalkyl, C₇-C₁₈-aralkyl radical, or aryl radical, and
R⁷ represents a C₁-C₂₂-alkyl, C₆-C₁₂-cycloalkyl, C₆-C₁₈-aryl, or C₇-C₁₈-aralkyl radical, and an unsaturated alkyl radical having 2-22, carbon atoms, or an alkoxypolyoxyalkylene radical.

20. The plasticizer as claimed in claim 19, wherein:
the ester is a polyester of 1,2-propanediol and/or 1,3- and/or 1,4-butanediol and/or diethylene glycol and/or dipropylene glycol and/or polypropylene glycol and/or glycerol and/or pentaerythritol and/or 2,2-dimethyl-1,3-propanediol with adipic acid and/or sebacic acid and/or succinic acid and/or phthalic acid, optionally also end-capped with acetic acid, and/or C₁₀-C₁₈-fatty acids, and/or 2-ethylhexanol, and/or isononanol and/or n-octanel and/or n-decanol and also di(2-ethylhexyl) adipate, diisononyl adipate, dipropylheptyl phthalate, diisononyl phthalate, diisononyl 1,2-cyclohexanedicarboxylate, di(2-ethylhexyl) 1,2-cyclohexanedicarboxylate, pentaerythritol tetravalerate and di(2-ethylhexyl) terephthalate, tri(2-ethylhexyl) trimellitate, diphenyl isodecyl phosphate, diphenyl 2-ethylhexyl phosphate, isopropylphenyl diphenyl phosphate, tart-butylphenyl diphenyl phosphate and phenyl (C₁₀-C₂₁)-alkanesulfonate; and
a ratio of (b) to (a) is 200:1 to 10:1 parts by weight.
